(19) United States
(12) Patent Application Publication
(10) Pub. No.: US 2003/0023437 A1
(43) Pub. Date: Jan. 30, 2003

(54) System and method for context-based spontaneous speech recognition

(76) Inventor: Pascale Fung, Clear Water Bay (HK)

Correspondence Address: Chiahua George Yu, Law Offices of C. George Yu, Ste. 210, 1250 Oakmead Pkwy., Sunnyvale, CA, 94085, US

(21) Appl. No.: 10/060,031

(22) Filed: Jan. 28, 2002

Related U.S. Application Data
(60) Provisional application No. 60/264,660, filed on Jan. 27, 2001.

(51) Int. Cl. G10L 15/00

(52) U.S. Cl. 704/236

(57) ABSTRACT

A system and method for processing human language input uses collocation information for the language that is not limited to N-gram information for N no greater than a predetermined value. The input is preferably speech input. The system and method preferably recognize at least a portion of the input based on the collocation information.

### CROSS REFERENCE TO RELATED APPLICATIONS

This claims the benefit of priority from commonly-owned U.S. Provisional Patent Application No. 60/264,660, filed on Jan. 27, 2001, entitled “System and Method for Context Based Spontaneous Speech Recognition and Verification”, which is hereby incorporated by reference in its entirety for all purposes.

### BACKGROUND OF THE INVENTION

The present invention relates to computer-assisted processing of human language input. The present invention is especially relevant to the processing of spontaneously uttered human speech.

In a typical automated spoken language system (SLS), a machine accepts spoken input and responds to the content of that input. Consider the following example. A user connects to a telephony server from the user's telephone. The user utters a query such as “how is the weather in San Francisco, Calif.” into the telephone's handset. In response, the telephony processes the user's utterance and somehow is able to provide the correct answer in audio form: “Foggy, 53 degrees Farenheit”. In short, a user speaks, and a machine tries to recognize at least some of the words that were spoken and to perform some action relevant to the recognized word(s).

An early-developed type of SLS requires its human users to speak utterances that each conform to a pre-defined and rigid finite-state grammar. Such systems are of only limited use because relatively few people would be willing to invest the time and discipline required to learn and adhere to a specific rigid grammar for each SLS to be used.

Another type of SLS uses traditional word-spotting techniques to identify just one or few keywords within an utterance while ignoring the remaining words. These systems would be programmed to spot keywords from a predetermined vocabulary of keywords. Traditional word-spotting techniques use extremely permissive, almost degenerate grammars in order to tolerate spontaneous utterances that might not follow any predetermined grammar. The flexibility granted by such permissive grammars, however, means that if the vocabulary of keywords becomes even moderately large, for example, more than about one hundred keywords, then the word-spotting system will suffer intolerably high false-detection errors. In short, traditional word-spotting techniques are not suitable for handling complex tasks that might involve many keywords in the keyword vocabulary.

Another type of SLS is, essentially, a sort of compromise between the early rigid-grammar system and the traditional free-grammar word-spotting system. This type of SLS essentially includes a conventional high-performance automatic dictation system that is referred to as a conventional (automatic) Large-Vocabulary Continuous Speech Recognition (LVCSR) system. The conventional LVCSR system produces a transcript the user's utterance, or multiple (N-best) alternative transcripts of the user's utterance, and the remainder of the SLS system tries to respond to the transcript(s). The conventional LVCSR system uses a conventional statistical word model as the “grammar”.

The conventional statistical language model is typically an N-gram model that has been trained from a training corpus of text sentences. An N-gram model essentially characterizes the likelihood that a user would utter a particular word, given that the user has already just uttered a particular sequence of N−1 words (i.e., N minus one words) in the utterance. For example, a tri-gram model might have a numerical likelihood P(“ice cream”|“I”, “like”) that is higher than a numerical likelihood P(“lice”|“I”, “like”).

One problem with the conventional LVCSR system, as used in SLSs, is that the actual input utterances typically are made up of spontaneous speech that contain hesitations and out-of-vocabulary sounds (e.g., coughs, “ums”) and “unlikely” word combinations according to the conventional statistical word model. The conventional LVCSR system simply cannot transcribe such input utterance with great accuracy. Accordingly, the transcription(s) produced by the conventional LVCSR system are likely to contain words that are incorrect, i.e., words that were not actually spoken.

### SUMMARY OF THE INVENTION

What is needed is a system and a method for computer-assisted processing of human language input, especially spontaneously spoken utterances, that has most of the advantages of the conventional LVCSR system but that does not suffer from limitations due to use of only N-gram language models. /*** long distance, order independent, distance independent ****/

According to one embodiment of the present invention, a method ****

According to another embodiment of the present invention, a system ****

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative

FIG. 1 is a schematic block diagram that illustrates a computer system that may be used for implementing the present invention.

FIG. 2 is a schematic block diagram that illustrates a software system for controlling the computer system of FIG. 1.

FIG. 3 is a schematic flow diagram that illustrates a method for determining certain language units (e.g., phrases, e.g., words) as being more useful than others based on collocation information other than mere conventional N-gram language model.

FIG. 4 is a schematic block diagram that illustrates a speech processing system according to an embodiment of the present invention.

FIG. 5 is a schematic flow diagram that illustrates a method for automatically recognizing speech that uses collocation information other than mere conventional N-gram language model.

FIG. 6 is a schematic block diagram that illustrates an embodiment of the speech processing system of FIG. 4.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles below are terse and are for convenience only.

I. Computer-based Implementation

A. Basic System Hardware (e.g., for Server or Client Computers)

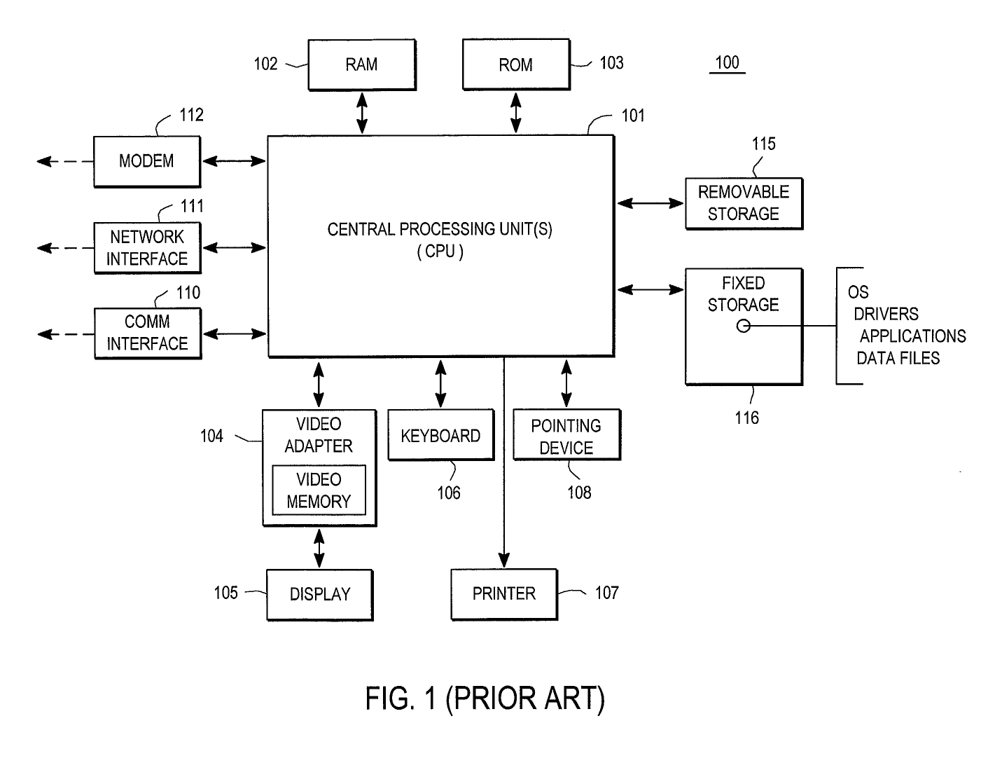

The present invention may be implemented using any competent computer system(s), for example, a Personal Computer (PC). FIG. 1 is a schematic diagram for a computer system 100. As shown, the computer system 100 comprises a central processor unit(s) (CPU) 101 coupled to a random-access memory (RAM) 102, a read-only memory (ROM) 103, a keyboard 106, a pointing device 108, a display or video adapter 104 connected to a display device 105 (e.g., cathode-ray tube, liquid-crystal display, and/or the like), a removable (mass) storage device 115 (e.g., floppy disk and/or the like), a fixed (mass) storage device 116 (e.g., hard disk and/or the like), a communication port(s) or interface(s) 110, a modem 112, and a network interface card (NIC) or controller 111 (e.g., Ethernet and/or the like). Although not shown separately, a real-time system clock is included with the computer system 100, in a conventional manner. The shown components are merely typical components of a computer. Some components may be omitted, and other components may be added, according to user choice.

The computer system 100 is utilized to receive or contain input. The computer system 100 then, under direction of software according to the present invention, operates upon the input according to methodology of the present invention to produce desired output, which are then displayed or otherwise output for use. The computer system 100, as shown and discussed, corresponds to merely one suitable configuration. Any other competent computer system and configuration is also acceptable.

The CPU 101 comprises a processor of the Pentium® family of microprocessors. However, any other suitable microprocessor or microcomputer may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory (RAM) 102 serves as the working memory for the CPU 101. In a typical configuration, RAM of at least sixty-four megabytes is employed. More or less memory may be used without departing from the scope of the present invention. The read-only memory (ROM) 103 contains the basic input output system code (BIOS)—a set of low-level routines in the ROM 103 that application programs and the operating systems can use to interact with the hardware, including reading characters from the keyboard, outputting characters to printers, and so forth.

Mass storage devices 115 and 116 provide persistent storage on fixed and removable media, such as magnetic, optical or magnetic-optical storage systems, or flash memory, or any other available mass storage technology. The mass storage may be shared on a network, or it may be a dedicated mass storage. As shown in FIG. 1, fixed storage 116 stores a body of programs and data for directing operation of the computer system, including an operating system, user application programs, driver and other support files, as well as other data files of all sorts. Typically, the fixed storage 116 comprises a main hard disk of the system.

In basic operation, program logic (including that which implements methodology of the present invention described below) is loaded from the storage device or mass storage 115 and 116 into the main memory (RAM) 102, for execution by the CPU 101. During operation of the program logic, the computer system 100 accepts, as necessary, user input from a keyboard 106, a pointing device 108, or any other input device or interface. The user input may include speech-based input for or from a voice recognition system (not specifically shown and indicated). The keyboard 106 permits selection of application programs, entry of keyboard-based input or data, and selection and manipulation of individual data objects displayed on the display device 105. Likewise, the pointing device 108, such as a mouse, track ball, pen device, or the like, permits selection and manipulation of objects on the display device 105. In this manner, the input devices or interfaces support manual user input for any process running on the computer system 100.

The computer system 100 displays text and/or graphic images and other data on the display device 105. The display device 105 is driven by the video adapter 104, which is interposed between the display 105 and the system. The video adapter 104, which includes video memory accessible to the CPU, provides circuitry that converts pixel data stored in the video memory to a raster signal suitable for use by a cathode ray tube (CRT) raster or liquid crystal display (LCD) monitor. A hard copy of the displayed information, or other information within the computer system 100, may be obtained from the printer 107, or other output device. Printer 107 may include, for instance, a Laserjet® printer (available from Hewlett-Packard of Palo Alto, Calif.), for creating hard copy images of output of the system.

The system itself communicates with other devices (e.g., other computers) via the network interface card (NIC) 111 connected to a network (e.g., Ethernet network), and/or modem 112 (e.g., 56K baud, ISDN, DSL, or cable modem), examples of which are available from 3Com of Santa Clara, Calif. The computer system 100 may also communicate with local occasionally-connected devices (e.g., serial cable-linked devices) via the communication interface 110, which may include a RS-232 serial port, a serial IEEE 1394 (formerly “firewire”) interface, a Universal Serial Bus (USB) interface, or the like. Devices that will be commonly connected locally to the communication interface 110 include other computers, handheld organizers, digital cameras, and the like. The system may accept any manner of input from, and provide output for display to, the devices with which it communicates.

The above-described computer system 100 is presented for purposes of illustrating basic hardware that may be employed in the system of the present invention. The present invention however, is not limited to any particular environment or device configuration. Instead, the present invention may be implemented in any type of computer system or processing environment capable of supporting the methodologies of the present invention presented below.

B. Basic System Software

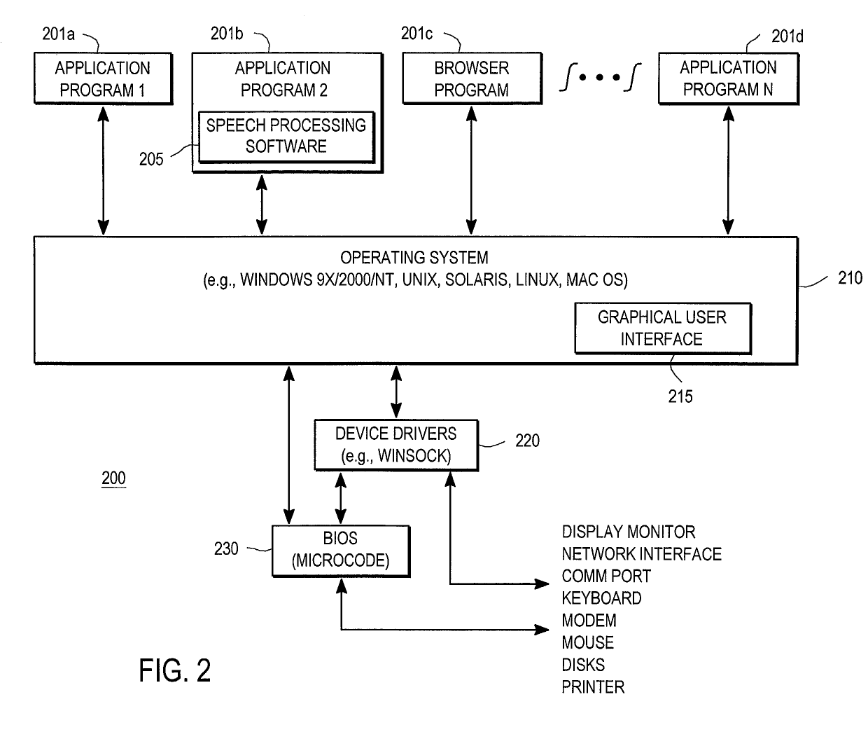

FIG. 2 is a schematic diagram for a computer software system 200 that is provided for directing the operation of the computer system 100 of FIG. 1. The software system 200, which is stored in the main memory (RAM) 102 and on the fixed storage (e.g., hard disk) 116 of FIG. 1, includes a kernel or operating system (OS) 210. The OS 210 manages low-level aspects of computer operation, including managing execution of processes, memory allocation, file input and output (1/0), and device I/O. One or more application programs, such as client or server application software or “programs” 201 (e.g., 201a, 201b, 201c, 201d) may be “loaded” (i.e., transferred from the fixed storage 116 of FIG. 1 into the main memory 102 of FIG. 1) for execution by the computer system 100 of FIG. 1.

The software system 200 preferably includes a graphical user interface (GUI) 215, for receiving user commands and data in a graphical (e.g., “point-and-click”) fashion. These inputs, in turn, may be acted upon by the computer system 100 in accordance with instructions from the operating system 210, and/or client application programs 201. The GUI 215 also serves to display the results of operation from the OS 210 and application(s) 201, whereupon the user may supply additional inputs or terminate the session. Typically, the OS 210 operates in conjunction with device drivers 220 (e.g., “Winsock” driver) and the system BIOS microcode 230 (i.e., ROM-based microcode), particularly when interfacing with peripheral devices. The OS 210 can be provided by a conventional operating system, such as a Unix operating system, such as Red Hat Linux (available from Red Hat, Inc. of Durham, N.C., U.S.A.). Alternatively, OS 210 can also be another conventional operating system, such as Microsoft® Windows (available from Microsoft Corporation of Redmond, Wash., U.S.A.) or a Macintosh OS (available from Apple Computers of Cupertino, Calif., U.S.A.).

Of particular interest, the application program 201b of the software system 200 includes software code 205 according to the present invention for processing human language human input, as is further described.

II. Speech Processing System

Embodiments of the present invention may be realized using an existing automatic speech processing system, e.g., one that uses Hidden Markov models (HMMs), by adding the method steps and computations described in the present document. For example, the existing automatic speech processing system may be a distributed speech recognition system, or other speech recognition system, for example, as discussed in the co-owned and co-pending U.S. patent application Ser. No. 09/613,472, filed on Jul. 11, 2000 and entitled “SYSTEM AND METHODS FOR ACCEPTING USER INPUT IN A DISTRIBUTED ENVIRONMENT IN A SCALABLE MANNER”, which is hereby incorporated by reference in its entirety, including any incorporations by reference and any appendices, for all purposes, and which will be referred to as “[PREVIOUS RECOGNIZER 2000]”.

Any other speech recognition system, for example, any conventional LVCSR system, may also be used to realize embodiments of the present invention, by adding the steps and modules as described in the present document. For example, the speech recognition systems described in the following papers may be used:

F. Alleva, X. Huang, and M. Y. Hwang, “An Improved Search Algorithm Using Incremental Knowledge For Continuous Speech Recognition”, in Proceedings of the 1993 Institute of Electrical and Electronic Engineers (IEEE) International Conference on Acoustics, Speech, and Signal Processing (ICASSP), Minneapolis, Minn., April 1993, pages 307-310; and

X. Aubert, C. Dugast, H. Ney, and V. Steinbiss, “Large vocabulary continuous speech recognition of wall street journal data”, in Proceedings of the 1994 IEEE ICASSP, Adelaide, Australia, April 1994, pages 129-132.

III. Overview

As will be further discussed, some preferred embodiments of the present invention include or relate to a system or method for providing automatic services via speech information retrieval. In these embodiments, a user can use spontaneous speech to access a data center to get the information that the user wants. For example, the system and method may be as discussed in the the co-owned and co-pending U.S. patent application Ser. No. 09/613,849, filed on Jul. 11, 2000 and entitled “SYSTEM AND METHODS FOR DOCUMENT RETRIEVAL USING NATURAL LANGUAGE-BASED QUERIES”, which is hereby incorporated by reference in its entirety, including any incorporations by reference and any appendices, for all purposes, and which will be referred to as “[PREVIOUS SLS 2000]”, supplemented or used as discussed in the present document. Any other SLS system or method may also be used, supplemented or used as discussed in the present document.

The speech information retrieval service, at least conceptually, may be considered to involve a speech recognition function that recognizes what the user said and a language understanding function that takes what the user said, for example, in the form of a transcript, and meaningfully responds to what the user said.

If perfect automatic speech recognition were to exist, then the line between speech recognition and language understanding could be drawn exactly: a perfect recognition subsystem (i.e., the perfect LVCSR dictation machine) would produce a perfect text transcript, and then an understanding subsystem would start with the perfect text transcript in order to process and meaningfully respond to it. However, because the perfect LVCSR system does not exist, the SLS embodiment of the present invention configures its speech recognition (sub)system and (sub)method to recognize speech in a way that deliberately tries to helps later understanding. Thus, even the nominal “recognition” (sub)system performs “understanding” functionality by attempting to obtain, as will be further discussed, hypothesized transcript(s), or recognition results, that are hopefully especially meaningful for the later understanding (sub)system and (sub)method. Embodiments of the present invention may be considered to be a part of a speech recognition (sub)system, or to be a part of (e.g., a front end of) a language understanding (sub)system, for example, the recognition and understanding subsystems of an SLS.

In real world environments, there are many out-of-vocabularie utterances and much utterance variation for a large user population. The extraneous words, hesitations, disfluencies and other unexpected expressions are common in spontaneous human speech. Thus, it is very difficult to get high text-to-speech accuracy by using conventional LVCSR technology. Thus, the approach to handle this problem in some SLS embodiments of the present invention is not simply to fruitlessly try to perfect LVCSR dictation. Such a goal is simply not yet approachable under any reasonable or practical system performance and efficiency, especially in cases where the possible vocabulary is not well specified or the statistical language model for the task is not reliably trained.

In daily spoken spontaneous language, there is a rich variation in the ways to express even an essentially singular idea. Nevertheless, even in the various expressions of the same idea, it is believed for embodiments of the present invention that content phrases related to the idea remain largely constant. By catching these key phrases, referred to for simplicity as keywords, embodiments of the present invention hope to capture and retain enough information for understanding the whole utterance well enough. It is believed for the present invention that catching the key phrases is important, and the precise ordering or spacing of the key phrases are is less important, given that variation of utterance style. Based on this assumption, the some SLS embodiments of the present invention include a Multiple Key Phrase Spotting (MKPS) approach to achieve spontaneous speech information retrieval. As will be seen, the MKPS approach, and its components, preferably make use of context or collocation that does not pay attention to content-phrase ordering or content-phrase spacing within an utterance (or other unit of input, such as passage, depending on the particular application).

IV. Extended Context: e.g., Non-N-Gram Collocation Measures

A. Prior Art: N-Gram Distributions

The N-gram distributions give information regarding which words (which, in the present document can also mean phrases) are likely to occur near each other. Such information is a type of context information or Collocation information. Context information or collocation information characterize in some way whether multiple words are likely to be found in context with one another. N-gram distributions are a rigid and short-distance form of context or collocation information because N-grams deal only with only contiguous words.

B. Collocation Measures that are not Fixed-N-Grams

Some embodiments of the present invention preferably use collocation information that is not a fixed-N-gram distribution. For example, some embodiments may use collocation measures that are not order-dependent, and/or that are not distance-dependent within an utterance (e.g., utterance-level collocation) or within a query (e.g., query-level collocation) or within a passage (e.g., passage-level collocation). In general, there are many possible collocation measures. In the prefered embodiment of the present invention pairwise collocation information is maintained such that, given two words, w₁, w₂, a score S{w₁,w₂} of the maintained collocation information is such that the score reflects the co-occurrence for these two words. For example, if S{w₁,w₂}>S{w₁, w₃}, then it is more useful to place w₁ and w₂ as content words/phrases in a same query than to place w₁ and w₃ as content words/phrases in a same query.

C. Preferred: Forms of Mutual Information Collocation Measure

In the preferred embodiment of the present invention, mutual information, or its like from information theory, is a form of collocation that is used. The order-independent, distance-independent, utterance-level collocation measure Score_{M1}( ) for two words w1 and w2 is given by:

$${Score}_{MI} ( w1 , w2 ) = log \frac{P ( w1 , w2 )}{P ( w1 ) P ( w2 )}$$

In the above formula, P(w1, w2) represents the probability that x and y occur together in the same utterance, and P(w1) and P(w2) are the probabilities that w1 and w2 respectively occur in a random utterance. The intuition behind the score is that if the words w1 and w2 do not tend to collocate, then their joint probability P(w1, w2) should simply equal P(w1) P(w2), and therefore the ratio should be near one and the score should be not much higher than zero. However, if the words w1 and w2 do collocate, then the ratio should exceed one and the score should be higher than zero.

An estimation using absolute frequencies from the training corpus for the collocation measure can be made as follows:

$${Score}_{MI} ( w1 , w2 ) \approx log \frac{f ( w1 , w2 )}{f ( w1 ) f ( w2 )}$$

In the above formula, f(w1, w2) is the absolute frequency of w1 and w2 together in the same utterance, and f(w1) and f(w2) are the single word frequencies, as observed in training.

Alternatively, a more strict formulation of Mutual Information may be used:

$${Score}_{MI} ( w1 , w2 ) = p ( w1 , w2 ) log \frac{p ( w1 , w2 )}{p ( w1 ) p ( w2 )}$$

where

$$p ( w1 , w2 ) = \frac{f ( w1 , w2 )}{f ( w1 ) + f ( w2 ) - f ( w1 , w2 )}$$

$$p ( w1 ) = \frac{f ( w1 )}{{\sum }_{i} f ( wi )}$$

$$p ( w2 ) = \frac{f ( w2 )}{{\sum }_{i} f ( wi )}$$

D. Consideration of Word Class

Word class information is used. A set of word classes is defined, and the word frequency for w1, f*(w1) is not simply the frequency of the w1 in the training corpus. It is the frequency of the word class for the w1. For example, suppose w1, w2, . . . wn, belong to same word class A. The frequency for wi in A is denoted by f(wi) and is defined as

$$f ( {w}_{1} ) = f ( w2 ) = … = {\sum }_{w ∈ A} word\_count ( w )$$

Word classes are further discussed in [Previous SLS 2000].

E. Combination of bigram Score and MI Score

Optionally, the MI Score is integrated with the traditional word-class bigram score (as trained from the training corpus for the bigram) to obtain a hybrid score Score_{H}. In the coming formula for Score_{H}, P_{wc}(w₁|w₂) is the word-class bigram probability score:

P_{wc}(w₁|w₂)=P(C₁|W₂).P(w₁|C₁).P(w₂|C₂)

In the coming formula for Score_{H}, S_{MI} (w₁, w₂) is the mutual information score (either the more formal formulation or the more informal estimate); Score_{H} is the hybrid score calculate by merging the word-class bigram probability score and the Mutual information score:

Score_{H}(w₁, w₂)=P_{WC}(w₁|w₂)+B*S_{MI}(w₁, w₂)

B is simply a system parameter that should be tuned depending on the particular system being built using some test data according to standard system-tuning practice.

F. Still Other Collocation Measures

Still other collocation measures that are not purely fixed-N-Gram distributions may be used. For example Dice's coefficient, Jaccard Coefficient, Overlap coefficient, and cosine, and their like are all measures that can be used to measure collocation.

V. Embodiment: Reject “Suspect” Phrases Not Believed Useful for Understanding

A. Motivation

In a database retrieval system, e.g., a “search engine”, it is important to extract meaningful key phrases from the user's input query for use in searching. Thus, known “filler” phrases such as “what is”, “please tell me”, and “the” can be filtered out from the very outset, as has been discussed in [PREVIOUS RECOGNIZER 2000]. As a matter of terminology, key phrases may be referred to in the present document for convenience as “keywords”, with the understanding that a keyword may actually be a phrase made up of multiple words, unless otherwise described or unless context demands otherwise.

B. Example Input Sentence

Consider the two example sentence H1 and H2:

H1: “I want to go to De Coral and meet my friends and eat”

H2: “I want to go to the corral and meet my friends and eat”

In sentence H1, “De Coral” is a word that refers to a popular fast food restaurant chain called Cafe De Coral. The sentence H1 is represented as the set of non-filler “words” {“Want-go”, “De-Coral”, “meet-friends”, “eat”}. The sentence H2 is represented as the set of non-filler “words” {“Want-go”, “corral”, “meet-friends”, “eat”}.

The words “eat” and “De-Coral” have very high collocation score. Because of the distance between the two words, though, a convention ti-gram language model would not be able to contribute a score to the recognition of De-Coral and eat. Thus, in choosing between the two hypothesized sentences H1 and H2, a speech recognition system would not possess the semantic knowledge that “eat” and “De-Coral” are much more likely to appear in a same sentence than “corral” and “eat”.

C. Rejecting or Giving a Low Score to Suspect Words

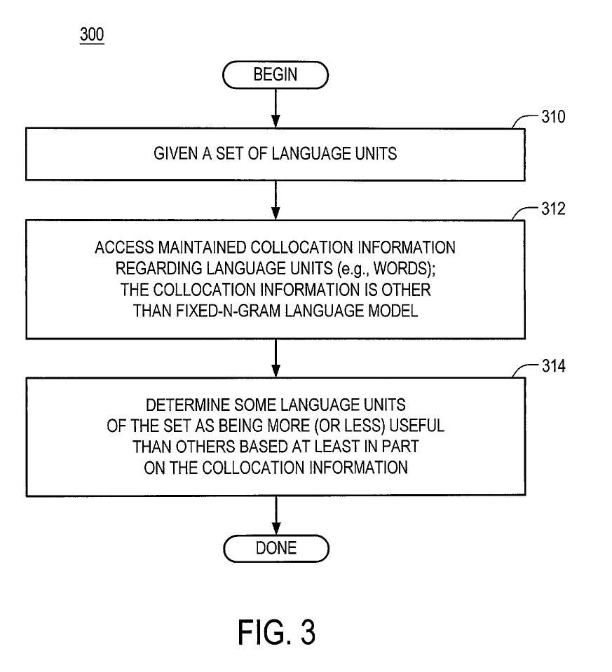

Using collocation information that are not merely fixed-n-gram language models, such as discussed above, the high collocation between “De-Coral” and “eat” and the lower collocation between “corral” and “eat” are made use of. FIG. 3 is a schematic flow diagram that illustrates a method 300 for determining certain language units (e.g., phrases, e.g., words) as being more useful than others based on collocation information other than mere conventional N-gram language model. The method 300 starts with a step 310 in which a set of language units is given for processing. For example, the set may be the non-filler “words” that represent the example sentence HI. Next, in a step 312, the method accesses maintained collocation information regarding language units, for example, the maintained non-N-gram collocation information. Next, in a step 314, the method determines some language units of the set as being more useful than others based at least in part on the colocation information. Alternatively, in the step 314, the method characterizes usefulness (e.g., by determining a score) of the set of language units or of members of the set of language units based at least in part on the collocation information. Preferably, usefulness is with regard to the tendency of such words to collocate in a set, according to linguistic knowledge. The set of words itself is sometimes referred to in other documentation as a “key phrase”. This usage would be different from the situation when a keyword is actually a lexicon entry that is made up of concatenated individual words.

1. Method 1: Threshold Vote by All Other Context Words

Given a set of words, such as those that represent sentence H2” {“Want-go”, “corral”, “meet-friends”, “eat”}, one way to “verify” a word in the set of words is to have its context words vote on it. In particular, in this method, first, take each word, one word at at time, as a candidate for rejection (i.e., eviction from the set of words). For that candidate word, determine whether its collocation measures with each of the other, context words falls below a predetermined or dynamically-determined threshold. If sufficiently many measures (e.g., a majority) of the scores fall below the threshold, then the candidate word is tentatively rejected. Using this method, the word “corral” is likely to be tentatively rejected because its collocation score is simply low with all of its context words.

Even if the candidate word is tentatively rejected, it is put back temporarily to serve as a context word when each other word is being evaluated as the candidate word. After all words have been evaluated as the candidate, all those that have been tentatively rejected are officially rejected. Alternatively, only the most “unpopular” one or several of the tentatively rejected words are actually rejected.

The threshold mentioned above is either a hand-tuned system threshold, or preferably the threshold is a computed threshold that is based on a statistical significance test, for example, for the mutual information score, a t-score threshold, defined as:

$$t = \frac{P ( w1w2 ) - P ( w1 ) P ( w2 )}{\sqrt{\frac{1}{K} P ( w1w2 )}}$$

In the above, K is the number of sentences in the training corpus for the mutual information collocation scores.

2. Method 2: Is One Context Word Exceptionally Collocative?

Given a set of words, such as those that represent sentence H1” {“Want-go”, “De-Coral”, “meet-friends”, “eat”}, one way to “verify” one word from the set of words is to consider how much its “best” context word is collocative with it. Again, take each word, one word at at time, as a candidate for rejection (i.e., eviction from the set of words). For that candidate word, determine its “best” context word.

In one embodiment, the “best” context word is the context word that has a higher collocation score with the candidate than does any other context word. In this embodiment, next determine the candidate's “second best” context word. The “second best” context word is the context word that has a higher collocation score with the candidate than does any other context word other than the “best” context word. If the best context word is much better than the second best context word, then some function of the collocation scores is thresholded to determine whether to tentatively reject the candidate word. For example, the function of the ratio may be the ratio minus a ratio between the target's collocation scores with the second best and with the third best context word.

As with the voting method, the process is repeated with each word as the candidate word, and at the end, either all the tentatively rejected words are actually rejected or only the least popular some of them are actually rejected. Again, the threshold may either by tuned by ad hoc methods according to typical practice or may be computed based on a confidence score that is appropriate for the particular collocation measure being employed. Using this method, the words “De-Coral” and “Eat” in the example would give each other exceptionally high scores and would ensure that neither is rejected.

3. Method 3: Separate A Pair of Incompatible Words

Another method is to simply consider and threshold all pairwise collocation scores. If any such score falls below the threshold, then that is an indication that the two words w1 and w2 involved are incompatible. Therefore, the set is separated into two sets, one without w1 and one without w2. Later, whole-set rescoring or some other scheme, for example, by the subsequent natural language understanding system is used to choose the best set.

4. Method 4: Ordinal Voting

Another method is to have every word rank-order that word's collocation scores with every other word. Thus, every word has a score-sheet listing that word's “favorite” through “least favorite” context word. Given a target word, the target word appears on all of the target word's context words' score-sheets. In effect, the context words are like Olympic judges, and the question is asked whether the target word is the “favorite” or “second favorite” or at least more favorite than some N-th favorite of at least one “judge”. If not, then that means that the candidate word is at most a “wallflower” that does not inspire intense feelings from anyone else, and should be rejected.

5. Other Methods

Still other rejection methods similar to the above, or that are permutations or combinations of the above, are possible and would be apparent to those of ordinary skill in the relevant art.

IV. An Embodiment: Improving Recognition of Content Phrases from Speech

A. Using Collocation Measures With Speech Recognition

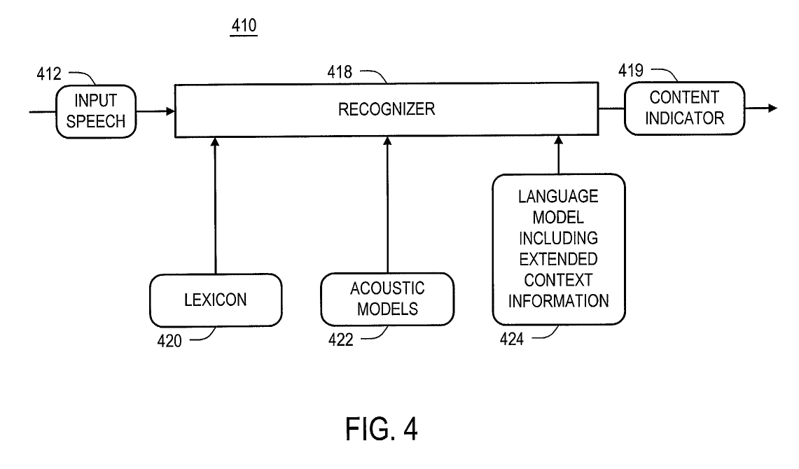

FIG. 4 is a schematic block diagram that illustrates a speech processing system 410 according to an embodiment of the present invention. As shown, speech input 412 is accepted by a recognizer 418 and the recognizer 418 produces, based thereupon, an indicator 419 of the content of the input speech 412. For example, the indicator 419 might be the “best” hypothesized sentence transcription or set of keywords that has been recognized from the input speech. The recognizer 418 uses a lexicon 420, acoustic models 422, and language model information 424. If the recognizer 418 is an LVCSR system, and the language model information 424 were just conventional n-gram language model information for LVCSR, then FIG. 4 would merely illustrate prior art. However, the language model information 424 includes extended context information that is not merely fixed-n-gram information, the recognizer 418 is programmed to use the extended context information, and FIG. 4 illustrates an embodiment of the present invention. The speech processing system 410 includes the recognizer 418. The lexicon 420, the acoustic models 422, and the language model information 424 may be considered to be a part of the speech processing system 410, or may be considered merely to be reference data used by the speech processing system 410.

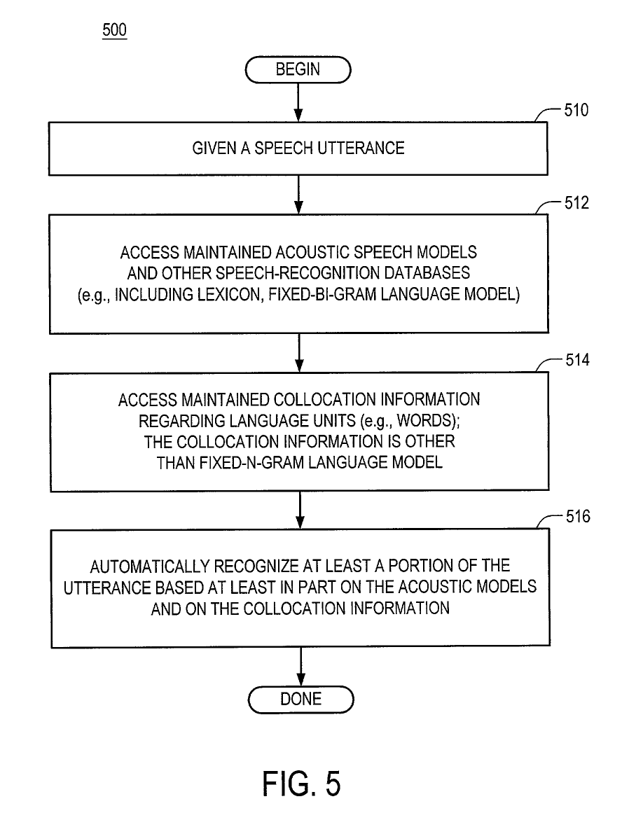

FIG. 5 is a schematic flow diagram that illustrates a method 500 for automatically recognizing speech that uses collocation information other than mere conventional N-gram language model. In a step 510 in which a speech utterance is given by a use for processing. For example, the utterance might be the example “I want to go to De Coral to meet my friends and eat”. Next, in a step 512, the method accesses maintained speech recognition databases, for example a lexicon and acoustic modes1. The speech recognition databases may also include an n-gram (e.g., bi-gram) language model. Next, in a step 514, the method accesses maintained extended context information, for example, collocation information regarding language units (e.g., phrases, e.g., words). The collocation is preferably as has been described—e.g., non-fixed-n-gram, utterance-based, order-independent, and/or distance independent. Next, in a step 516, the method automatically recognizes at least a portion of the utterance based at least in part on the acoustic models and on the collocation information. The speech recognition databases of the step 512 may simply be conventional LVCSR databases.

B. Extended Collocation-Based Measure Substitutes/Supplements Bi-Gram

Conventional LVCSR systems are well known and are described, for example, in the incorporated [PREVIOUS RECOGNIZER 2000] and in the other mentioned references. Conventional LVCSR systems frequently use a bi-gram language model. According to an embodiment of the method 500, a modified conventional LVCSR system is used, e.g., in the preferred SLS embodiment of the present invention. The LVCSR system is modified in that, instead of using a bi-gram language model to contribute a language-model score to a sentence hypothesis during decoding, a collocation measure-based score is used. For example, during a search phase, for example, in a stack decoder or in a Viterbi search, when a new word is added to hypotheses that is being grown, a conventional LVCSR system contributes a bi-gram score based on the identity of the new word and its previous word. Under the new scheme, a collocation measure-based score is substituted for the bi-gram score during the decoding search. The substituted score may be defined using a mutual-information score Score_{MI}, which has been discussed above. The substituted score may be:

$$Score ( w1 , w2 ) = α \cdot {Max}_{i = 1 , … , n - 1} {Score}_{MI} ( {w}_{n} , {w}_{i} )$$

In the above, the parameter α is empirically decided by the word insertion penalty with a direct ratio relationship. As can be seen, instead of basing the score on just the immediate context, the score is based the best (most collocative) already-seen context word. Other formulations are possible. For example, the earlier-discussed hybrid formula that combines bi-gram and (mutual information) collocation measure-based scores may be used.

C. Extended Collocation-Based Measure Substitutes/Supplements Tri-Gram

Conventional LVCSR systems also make use of ti-gram scoring (or re-scoring) of full or partial sentence hypotheses. According to an embodiment of the method 500, collocation-based scoring is used instead of, or in hybrid with, tri-gram scoring.

In an example embodiment, The substituted score may be:

$$Score ( sentence ) = \frac{1}{{C}_{n}^{2}} {\sum }_{i , j = 1 , … , n ; i \neq j} {Score}_{MI} ( {w}_{i} , {w}_{j} )$$

VI. Further Details: Implementation Details for an Example Embodiment

A. An Exemplary System

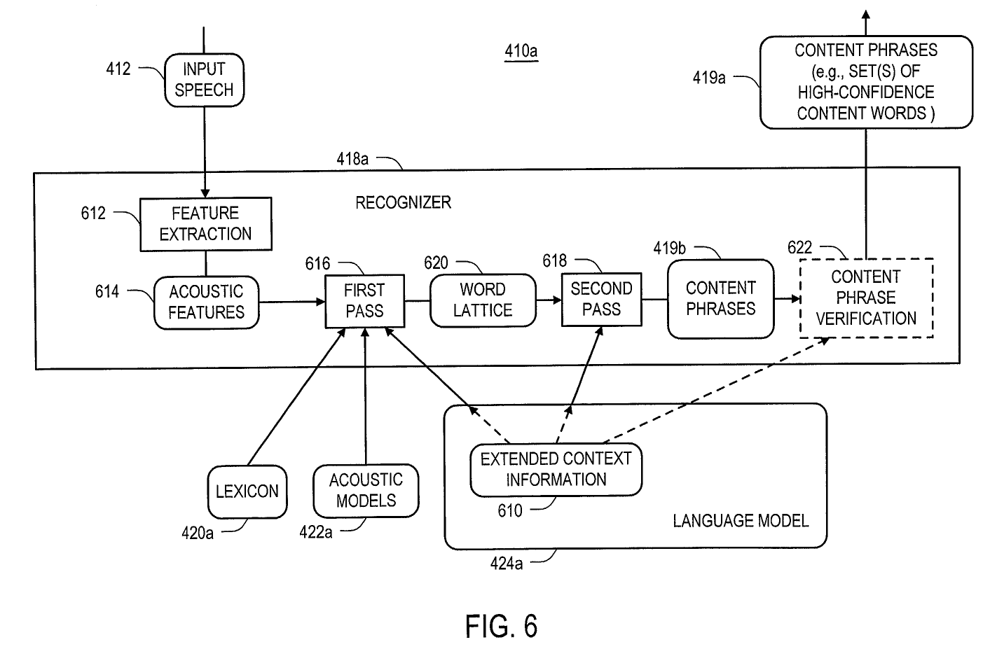

FIG. 6 is a schematic block diagram that illustrates an embodiment 410a of the speech processing system 410 of FIG. 4. The embodied system 410a includes a recognizer 418a that accepts an input speech utterance 412 and produces content phrase(s) (e.g., N-best phrases where each phrase is a set of content words). As is shown, the recognizer 418a includes LVCSR databases lexcicon 420a, acoustic models 422a, and language model 424a. The language model 424a includes collocation information 610. The recognizer 418a includes a feature extractor 612 that extracts acoustic features 614 in conventional manner. The recognizer 418a uses a modified two-pass A*-admissible stack decoder having a first pass 616 and a second pass 618. Output 620 of the first pass is a set of scored sentence hypotheses as well as word start and end-times associated with the hypotheses. The start and end times are recorded prior to merging state sequence hypotheses into a common hypothesis when they correspond to a same word sequence. The output 620 can be considered to be a word lattice. The output of the second pass 618 is a set 419b of hypothesized content phrases. The hypothesized content phrases 419b are preferably verified by a verifier 622, to produce recognizer output 419a that is verified and is therefore considered to be of high confidence.

The feature extractor 612 can be of any conventional type, and may be as discussed in [PREVIOUS RECOGNIZER 2000]. The first pass 616, prior to use (if any) of collocation measure-based scoring is as has been discussed in [PREVIOUS RECOGNIZER 2000]. The word lattice 620, as has been mentioned includes sentence hypotheses and timing alignment information for corresponding word segments. The lexicon 420a is a tree lexicon as has been discussed in [PREVIOUS RECOGNIZER 2000]. The acoustic model 422a can be of any conventional type, for example may include 16 mixture in 39 dimensions. The language model may include bi-gram language models and tri-gram language models in addition to the extended context information 610. The extended context information 610 has been extensively discussed.

As shown by the dashed lines connected thereto, the extended context information 610 may be used in the first pass 616 (to replace or supplement bi-gram scoring), in the second pass 618 (to replace/supplement tri-gram re-scoring), and/or in the content phrase verifier 622 for performing rejection or scoring low of suspect words.

The content phrase verifier 622, as suggested above, may include the function of rejecting or scoring low of suspect words as discussed in connection with FIG. 3. In addition, the content phrase verifier includes the verification function that is further discussed below and in LAM, Kwok Leung and FUNG, Pascale, “A More Efficient and Optimal LLR for Decoding and Verification”, Proceedings of IEEE ICAS SP 1999, Phoenix, Ariz., March 1999 (currently downloadable from the internet at http://www.ee.ust.hk/˜pascale/eric.ps ).

B. An Exemplary Detailed Methodology

An implementation of a two-pass LVCSR decoder is described, which can then be modified as discussed above.

1. Two-Pass LVCSR Decoder

The search strategy of our LVCSR decoder is basically a two pass time synchronous beam decoder. In the first forward pass, a frame synchronous viterbi beam decoder is exploited on the tree organized lexicon as well as a bigram-backoff language model to generate a hypothesis word lattice for the subsequent decoding pass. The second backward pass depends on this lattice and aims to extract the best word sequence from it by using the high order n-gram language model, e.g. tri-gram.

First Pass with Bigram

### (a Frame-synchrous Viterbi Beam Decoder)

(1). The search function algorithm:

a. Set t=0, and push initial lexical state 0 into Stack(t).

b. Pop the best lexical state hypothesis s out of the Stack(t);

c. For each lexical state in the lexicon tree that follow s

c.1. perform state transition with acoustic score and language mode score as described in the extension function;

c.2. and push newly created lexical states into the extension stack.

d. If Stack(t) is not empty, then go to step b;

e. Prune the extension stack and perform path merger, then push the top N item into Stack(t+1); (But record the alignments before path merger.)

f. Increase time t by 1, and go to step b until the whole sentence is decoded.

(2). The extension function algorithm:

Get all the possible extend states of the current state;

If the transition is inside the current model

Calculate the extended likelihood, and push the extended state in the Extended Stack.

If the transition is outside of the current model

Get all the possible extended model of the current model from the Lexicon Tray, and extend to the first state of these model.

If the transition is right at the word end

Add Bigram score in the path likelihood, and back to the first item of the Lexicon Tray, and extend all the following item.

Second Pass with Trigram

a. Set t=T and push initial sentence hypothesis into stack(T) of all ending words from any hypothesis in the word lattice.

b. Pop the best sentence hypothesis h from stack(t).

c. For each word w in lattice with its end time t

c.1 perform path extension with trigram rescore, and push newly created path h into stack(t=the start time of w).

c.2 perform path merger, beam width pruning.

d. If stack(t) is not empty, go to step b.

e. Decrease time t by 1, and go to step b until the whole lattice is decoded.

The content phrase verifier 622 uses the following algorithm.

The general technique of utterance verification is using the log likelihood ratio (LLR) as the confidence measure. The commonly used confidence measure is the discriminative function

$$LLR = log \frac{P ( O \vert {H}_{0} )}{P ( O \vert {H}_{1} )}$$

For HMM implementation, the formula is as follows,

$$LLR = log \frac{{b}_{j}^{c} ( {o}_{t} )}{{max}_{k = 1}^{N} {b}_{k}^{a} ( {o}_{t} )}$$

where N is the number of state, c is the correct model, a is the alternative model and t is the time.

A phone garbage model which is trained from all phonemes is used as alternative model. The garbage model is 3-state and 64 mixtures HMM.

Since our task is based on subword units HMMs. The confidence measure for the word string is computed based on the confidence score of the subword units.

$${LLR}_{sbuword} = \frac{1}{T} {\sum }_{t = 1}^{T} log \frac{{b}_{j} ( {o}_{t} )}{{max}_{k = 1}^{N} {b}_{k}^{n} ( {o}_{t} )} ,$$

where N is the number of states of each model and T is the duration of the subword model

The normalized LLR_{word} is used as confidence measure for verification

$${LLR}_{word} = \frac{1}{N} {\sum }_{n = 1}^{N} {LLR}_{n} ,$$

where N is the number of subword units for the word string

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

What is claimed is:

1. In an information processing system, a method for speech recognition, the method comprising the steps of:
accepting a speech utterance;
accessing maintained collocation information regarding language units, wherein the collocation information is indicative of collocation and is not merely N-gram information for N no more than a predetermined value; and
recognizing at least a portion of the speech utterance based on the collocation information.

2. A system for automated speech recognition, the system comprising:
means for accepting a speech utterance;
means for accessing maintained collocation information regarding language units, wherein the collocation information is indicative of collocation and is not merely N-gram information for N no more than a predetermined value; and
means for recognizing at least a portion of the speech utterance based on the collocation information.
